(19) United States
(12) Patent Application Publication
(10) Pub. No.: US 2019/0080641 A1
(43) Pub. Date: Mar. 14, 2019

(54) WEARABLE MONOCULAR GLASSES, COMBINED BINOCULAR GLASSES SYSTEM AND CONTROL METHODS THEREOF

(71) Applicant: BOE TECHNOLOGY GROUP CO., LTD., Beijing (CN)

(72) Inventor: Naifu WU, Beijing (CN)

(21) Appl. No.: 15/992,902

(22) Filed: May 30, 2018

(30) Foreign Application Priority Data
Sep. 14, 2017 (CN) 201710828546.X

(51) Int. Cl. G09G 3/20; G06F 3/14; G02B 27/01

(52) U.S. Cl. CPC G09G 3/2092; G06F 3/1423; G02B 27/0176; G02B 2027/0132; G09G 2354/00; G02B 2027/0178; G02B 27/0172

(57) ABSTRACT

The present disclosure provides wearable monocular glasses, a combined binocular glasses system and control methods thereof. The wearable monocular glasses includes: an optical imaging components; a direction sensor which is fixed relative to the optical imaging component and configured to detect a wearing state of the wearable monocular glasses; a frame fixedly connected to the optical imaging component for enabling a user to wear the wearable monocular glasses in different wearing states; and a control circuit communicatively connected to the direction sensor and the optical imaging component respectively and configured to output image data corresponding to the wearing state of the wearable monocular glasses to the optical imaging component.

### CROSS-REFERENCE TO RELATED APPLICATIONS

This application is based on and claims priority to Chinese Patent Application No. 201710828546.X, filed on Sep. 14, 2017, the entire contents thereof are incorporated herein by reference.

### TECHNICAL FIELD

The present disclosure relates to wearable monocular glasses, a combined binocular glasses system and control methods thereof.

### BACKGROUND

Augmented Reality (AR) is a technique for calculating a position and an angle of a camera for photography and adding a corresponding image in real time. The goal of this technique is to show a virtual world overlapped with a real world at the same time on a screen and interactions can be performed. The augmented reality technology simulates and overlaps physical information (visual information, sound, taste, touch, etc.) in a certain time and space range in the real world by means of scientific technologies, such as computer technologies, and thus applies the virtual information to the real world. The virtual object and the real environment coexist in the same picture or space by overlapping with each other in real time, so that the user can get an excellent experience beyond the reality.

Augmented reality glasses, as a wearable virtual reality device, due to the advantages of easy to use, easy to carry, can bring conveniences to people in daily life. The augmented reality glasses have been widely used. The augmented reality glasses not only can be used to take photos, record videos and other functions, but also can support the user entertainment, social, travel navigation and other operations.

The augmented reality glasses usually include monocular glasses and binocular glasses, which are respectively used for monocular wearing and binocular wearing. For different usage scenarios and purposes, the monocular glasses and the binocular glasses each have their advantages and disadvantages. In the need of use in a variety of scenes, it is often needed to equip with both the monocular glasses and the binocular glasses, so as to replace the monocular glasses and the binocular glasses according to different scenes. In addition, the monocular glasses are also divided into left-eye monocular glasses and right-eye monocular glasses. In this way, the user's cost is increased, and the user experience satisfaction is greatly reduced due to a frequent replacement.

### SUMMARY

In one aspect of the embodiments of the present disclosure, there is provided wearable monocular glasses, including: an optical imaging component; a direction sensor which is fixed relative to the optical imaging component and configured to detect a wearing state of the wearable monocular glasses; a frame fixedly connected to the optical imaging component for enabling a user to wear the wearable monocular glasses in different wearing states; and a control circuit communicatively connected to the direction sensor and the optical imaging component respectively and configured to output image data corresponding to the wearing state of the wearable monocular glasses to the optical imaging component.

Optionally, the frame includes: a supporting leg and a bending part connected with each other; one end of the supporting leg is fixedly connected with the optical imaging component, and the other end of the supporting leg is movably connected with the bending part so as to rotate the bending part to an angle corresponding to the wearing state of the wearable monocular glasses; or the supporting leg is fixedly connected with the bending part, and the supporting leg is movably connected with the optical imaging component so as to rotate the frame to an angle corresponding to the wearing state of the wearable monocular glasses.

Optionally, a rotation axis of the bending part has the same direction as a center line of the supporting leg; or a rotation axis of the frame has the same direction as an extending line of a root part of the supporting leg.

Optionally, the wearable monocular glasses according to the embodiments of the present disclosure further includes: a top bracket, wherein a connection end of the top bracket is movably connected to the optical imaging component so that a free end of the top bracket rotates to a head fixed position corresponding to the wearing state of the wearable monocular glasses.

Optionally, the wearable monocular glasses according to the embodiments of the present disclosure further includes: a connection part communicatively connected with the control circuit, wherein the connection part is configured to connect with a connection part of another wearable monocular glasses and transmit a data indication signal or image data between the control circuits of two wearable monocular glasses which are connected to each other, the data indication signal being used for indicating binocular display image data.

Optionally, in a case where the wearable monocular glasses further comprise: a top bracket, the connection part is provided at a free end of the top bracket.

Optionally, the connection part includes: a plurality of signal terminals arranged in a linear arrangement; and a magnetic attraction member disposed around the plurality of signal terminals; wherein every two symmetrically arranged signal terminals among the plurality of signal terminals are respectively connected to two pins of the same type of the control circuit; or every two symmetrically arranged signal terminals among the plurality of signal terminals are connected to the same pin of the control circuit.

Optionally, the connection part further includes: an insulating layer disposed on other surfaces of the magnetic attraction member besides a connection surface of the connection part.

Optionally, the signal terminal includes: a bottom conductor, an elastic conductor and a contact which are sequentially connected, the bottom conductor and the elastic conductor are enclosed in the magnetic attraction member of the connection part, and the contact is exposed from a surface of a connection surface of the connection part.

Optionally, the magnetic attraction member is an electromagnetic generator.

Optionally, the magnetic attraction member includes: a magnet and a magnetic metal respectively located at two sides of a symmetry line of the plurality of signal terminals.

According to another aspect of the embodiments of the present disclosure, there is provided a method for controlling wearable monocular glasses, including: obtaining a current wearing state of the wearable monocular glasses; and displaying according to image data corresponding to the current wearing state of the wearable monocular glasses.

The displaying according to the image data corresponding to the wearing state of the wearable monocular glasses includes: when the current wearing state of the wearable monocular glasses is a preset state of the wearable monocular glasses, displaying according to image data corresponding to the preset state of the wearable monocular glasses, the preset state being one of wearing states of the wearable monocular glasses; and when the current wearing state of the wearable monocular glasses is not the preset state of the wearable monocular glasses, adjusting image data corresponding to the preset state of the wearable monocular glasses to image data corresponding to the current wearing state of the wearable monocular glasses and displaying the adjusted image data.

According to the other aspect of the embodiments of the present disclosure, there is provided a combined binocular glasses system including: first wearable monocular glasses and second wearable monocular glasses which are connected by connection parts, wherein both the first wearable monocular glasses and the second wearable monocular glasses are the above-described wearable monocular glasses. The control circuit of the first wearable monocular glasses and the control circuit of the second wearable monocular glasses are configured to transmit a data indication signal or image data through the connection parts connecting those control circuits with each other. The data indication signal is used for indicating binocular display image data, and the control circuit of the first wearable monocular glasses and the control circuit of the second wearable monocular glasses are respectively configured to output corresponding image data to respective optical imaging components according to the current wearing states of the first wearable monocular glasses and the second wearable monocular glasses.

According to further another aspect of the embodiments of the present disclosure, there is provided a method for controlling a combined binocular glasses system, wherein the combined binocular glasses system includes: first wearable monocular glasses and second wearable monocular glasses which are detachably connected. The method comprises: determining, by the first wearable monocular glasses, whether the first wearable monocular glasses is connected with the second wearable monocular glasses; when it is determined that the first wearable monocular glasses is connected with the second wearable monocular glasses, transmitting a data indication signal or image data between the first wearable monocular glasses and the second wearable monocular glasses, the data indication signal being used for indicating binocular display image data; and obtaining individual current wearing states, and displaying according to image data corresponding to individual current wearing states, by the first wearable monocular glasses and the second wearable monocular glasses.

### BRIEF DESCRIPTION OF THE DRAWINGS

To explain the technical solutions in the embodiments of the present disclosure or in the related art more clearly, hereinafter, the drawings required for describing the embodiments or the related art will be introduced simply. Obviously, the drawings described below are only some embodiments of the present disclosure. For the person skilled in the art, other drawings may be obtained according to these drawings without paying inventive labor.

FIG. 1 is a first structural schematic diagram of wearable monocular glasses according to an embodiment of the present disclosure;

FIG. 2 is a second structural schematic diagram of wearable monocular glasses according to an embodiment of the present disclosure;

FIG. 3 is a structural schematic diagram of the wearable monocular glasses shown in FIG. 2 which is flipped to the other side for wearing;

FIG. 4 is a third structural schematic diagram of wearable monocular glasses according to an embodiment of the present disclosure;

FIG. 5 is a schematic structural diagram of the wearable monocular glasses shown in FIG. 4 which is flipped to the other side for wearing;

FIG. 6 is a schematic structural diagram of wearable monocular glasses which further includes a top bracket according to an embodiment of the present disclosure;

FIG. 7 is a first schematic structural diagram of wearable monocular glasses which further includes a connection part according to an embodiment of the present disclosure;

FIG. 8 is a second schematic structural diagram of wearable monocular glasses which further includes a connection part according to an embodiment of the present disclosure;

FIG. 9 is a schematic structural diagram of a connection part in wearable monocular glasses according to an embodiment of the present disclosure;

FIG. 10 is a cross-sectional view taken along line A-A of FIG.

FIG. 11 is a schematic structural diagram in which a magnetic attachment member in a connection part in wearable monocular glasses is an electromagnetic generator according to an embodiment of the present disclosure;

FIG. 12 is a schematic structural diagram in which a magnetic attachment member in a connection part in wearable monocular glasses is a magnet and a magnetic metal that are symmetrically arranged according to an embodiment of the present disclosure;

FIG. 13 is a first flowchart of a method for controlling wearable monocular glasses according to an embodiment of the present disclosure;

FIG. 14 is a second flowchart of a method for controlling wearable monocular glasses according to an embodiment of the present disclosure;

FIG. 15 is a schematic structural diagram of a combined binocular glasses system according to an embodiment of the present disclosure; and

FIG. 16 is a flowchart of a method for controlling a combined binocular glasses system according to an embodiment of the present disclosure.

### DETAILED DESCRIPTION

Hereinafter, the technical solutions in the embodiments of the present disclosure will be described clearly and completely in conjunction with the accompanying drawings in the embodiments of the present disclosure, and it will be apparent that the described embodiments are merely part of the embodiments of the present disclosure and not all of the embodiments. All other embodiments obtained by those skilled in the art based on the embodiments of the present disclosure without creative work are within the protection scope of the present disclosure.

In the following embodiments, the so-called “same” may, for example, be exactly the same, or may be substantially the same (a difference or an error is within an engineering tolerable range, for example, not higher than 10%, or, not higher than 5%, etc.)

In the following embodiments, the direction sensor refers to a sensor that determines at least one direction based on at least one physical quantity. For example, it may be a gravity sensor, or may be a geomagnetic sensor, or may be an acceleration sensor, or may be a gyroscope sensor, or may be a combination of at least two direction sensors.

In the following embodiments, the wearable glasses (monocular, binocular) may be Virtual Reality (VR) glasses, Augmented Reality (AR) glasses, Mixed Reality (MR) glasses, Substitutional Reality (SR) glasses, Cinematic Reality (CR) glasses, or Real Reality (RR) glasses.

In the following embodiments, based on the types of the adopted wearable glasses, corresponding optical imaging components are adopted to display the image signals of different sources.

In the following embodiments, the control circuit may be implemented by operating related functional codes by various common processor architectures, For example, the control circuit may be implemented based on a central processing unit (CPU), such as a Microcontroller Unit (MCU), a Field Programmable Logic Array (FPGA), an Application Specific Integrated Circuits (ASIC), or a Digital Signal Processor (DSP). It will be readily understood that there is also a storage structure connected to the processor and storing the function codes for being loaded by the processor, such as a ROM, a Flash, a HDD, a SDD, and etc.

In the following embodiments, the so-called communication connection, signal transmission and the like may be transmitted through a wired connection, such as LAN, CAN, RS485, wires, etc., and also may be transmitted through a wireless connection, such as WiFi, ZigBee, WWAN, Bluetooth and the like.

An embodiment of the present disclosure provides wearable monocular glasses. As shown in FIG. 1, the wearable monocular glasses include: an optical imaging component 10; a direction sensor 20 which is fixed relative to the optical imaging component 10 and configured to detect a wearing state of the wearable monocular glasses; a frame 30 fixedly connected with the optical imaging component 10 for enabling a user to wear the wearable monocular glasses in different wearing states; and a control circuit 40 electrically connected with the direction sensor 20 and the optical imaging component 10, respectively, and configured to output image data corresponding to the wearing state of the wearable monocular glasses to the optical imaging component 10.

In the wearable monocular glasses according to the embodiments of the present disclosure, the optical imaging component 10 is configured to convert a virtual image signal inputted from the outside into a specific virtual image and project it onto a display surface, so that when wearing the wearable monocular glasses of the embodiments of the present disclosure, a user may see a complete virtual image through the display surface of the optical imaging component 10. Specific structures and connection relationships of the optical imaging component 10 in the embodiments of the present disclosure are not limited. Illustratively, the optical imaging component 10 may include a lens and a display screen (not shown in FIG. 1). The display screen is disposed on a side surface of the lens, and the display screen, after receiving a virtual image signal, converts the virtual image signal into a virtual image, and projects the virtual image onto the lens via the side surface of the lens. In this way, the user at the side of the lens may watch the complete virtual image on the lens. The lens in the optical imaging component 10 is not limited to the shape as shown in FIG. 1, and may have any shape as long as the complete virtual image can be displayed to the user.

In the wearable monocular glasses according to the embodiments of the present disclosure, the direction sensor 20 is configured to detect the wearing state of the wearable monocular glasses. In the embodiments of the present disclosure, the position of the direction sensor 20 on the optical imaging circuit 10 is not particularly limited.

Taking the gravity sensor as an example, the principle of piezoelectric effect is usually used to determine the direction of gravity. For an isopolar crystal having no symmetrical center, in addition to a deformation of the crystal, an external force applied on the crystal will change a polarization state of the crystal, and an electric field is established inside the crystal. Such a phenomenon of polarizing a medium due to a mechanical force is known as a positive piezoelectric effect. The gravity sensor takes advantages of the characteristics that the crystal is deformed due to accelerations. Since this deformation may cause a voltage, the acceleration may be converted into a voltage for output as long as a relationship between the generated voltage and the applied acceleration is calculated. For example, a gyro sensor is provided with a gyro in its interior. Since an axis of the gyro is always parallel to an initial direction due to the gyro effect, the direction may be calculated according to a deviation from the initial direction. With the provided direction sensor 20, the state of the optical imaging component 10 may be determined by fixing the relative position between the direction sensor 20 and the optical imaging component 10. Therefore, in the wearable monocular glasses according to the embodiments of the present disclosure, the arrangement position of the direction sensor 20 on the optical imaging component 10 is not specifically limited. For example, the direction sensor 20 may be provided above the optical imaging component 10 as shown in FIG. 1 or may be provided on either side of the optical imaging component 10 as long as the relative position between the direction sensor 20 and the optical imaging component 10 can be fixed without obstructing a complete sight line of the optical imaging component 10.

In the wearable monocular glasses according to the embodiments of the present disclosure, the wearing state of the wearable monocular glasses refers to a directional state of the wearable monocular glasses which are fitting with the left eye or a directional state of the wearable monocular glasses which are fitting with the right eye. For example, FIG. 1 illustrates the directional state of wearing on the right eye. The wearing state herein is not limited to the state in which the glasses are actually worn by the user.

In the wearable monocular glasses according to the embodiments of the present disclosure, the frame 30 is fixedly connected with the optical imaging component 10, which means that the frame 30 is directly connected with the optical imaging component 10 or is connected with the optical imaging component 10 through a connector. The fixed connection herein refers to a fixed relationship between the frame 30 and the optical imaging component 10 after the installation is completed, so that the user may wear the wearable monocular glasses of the embodiments of the present disclosure by fixing the frame 30 on the head or the like. However, in general, the frame 30 and the optical imaging component 10 are detachably connected with each other. That is, the fixedly connected frame 30 and the optical imaging component 10 may be separated by means of disassembly.

In the wearable monocular glasses according to the embodiments of the present disclosure, for the same wearable monocular glasses, the image for the left-eye wearing is flipped upside down with respect to the image for the right-eye wearing, and the switching of the image data may be realized after exchanging the left-eye wearing and the right-eye wearing by performing a corresponding processing on the image data. Therefore, the control circuit 40 is electrically connected with the direction sensor 20 and the optical imaging component 10 respectively, so that the control circuit 40 controls, according to the wearing state corresponding to the left eye or the wearing state corresponding to the right eye detected by the direction sensor 20, the image data in the optical imaging component 10 to be converted by a corresponding algorithm, so as to obtain the image data corresponding to the wearing state of the wearable monocular glasses.

In the wearable monocular glasses according to the embodiments of the present disclosure, the shape of the frame 30 is not particularly limited as long as the wearable monocular glasses can be fixed to the head of the wearer for both the left-eye wearing and the right-eye wearing, so that the wearable monocular glasses do not shake or fall off either the wearer wears them on the left eye or on the right eye.

An embodiment of the present disclosure provides wearable monocular glasses, including: an optical imaging component; a direction sensor which is fixed relative to the optical imaging component and configured for detecting a wearing state of the wearable monocular glasses; a frame fixedly connected to the optical imaging component for enabling a user to wear the wearable monocular glasses in different wearing states; and a control circuit electrically connected with the direction sensor and the optical imaging component respectively for outputting image data corresponding to the wearing state of the wearable monocular glasses to the optical imaging component. The wearing state of the wearable monocular glasses is detected by the direction sensor having a fixed relative position with the optical imaging component, and the detected signal is transmitted to the control circuit so that the control circuit may adjust the image data to the image data corresponding to the wearing state of the wearable monocular glasses correspondingly according to the wearing state of the wearable monocular glasses, so that a positive picture display matching with the wearing state may be realized in spite of the left-eye wearing state and the right-eye wearing state of the wearable monocular glasses. Meanwhile, the frame is fixedly connected to the optical imaging component, thereby the user may wear the wearable monocular glasses and a wearing stability of the wearable monocular glasses may be ensured during wearing.

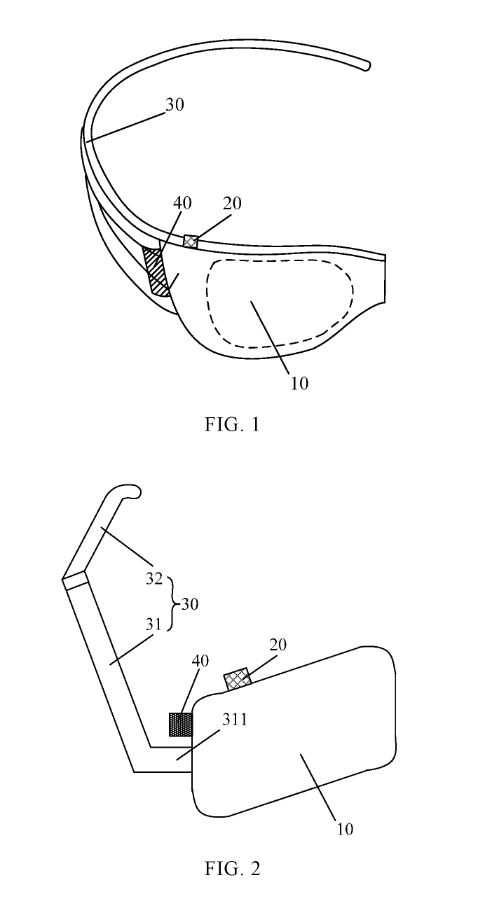

Optionally, as shown in FIG. 2, the frame 30 includes: a supporting leg 31 and a bending part 32 which are connected to each other. One end of the supporting leg 31 (such as, the root part 311) is fixedly connected with the optical imaging component 10, and the other end of the supporting leg 31 is movably connected with the bending part 32, so as to rotate the bending part 32 to an angle corresponding to the wearing state of the wearable monocular glasses.

Optionally, as shown in FIG. 4, the frame 30 includes the supporting leg 31 and the bending part 32 connected with each other. The supporting leg 31 is fixedly connected to the bending part 32, and the supporting leg 31 is movably connected to the optical imaging component 10, so as to rotate the frame 30 to an angle corresponding to the wearing state of the wearable monocular glasses.

The structure of the frame 30 as shown in FIG. 2 or FIG. 4 may be designed by a prefabricated manner to satisfy the wearing state of most of the users' heads corresponding to the left eye or the right eye. In order to realize a flexible adjustment in various situations, in the structure of the frame 30 shown in FIG. 2, the axis of rotation of the bending part 32 has the same direction as a center line of the support leg 31; or, in the case of the structure of the frame 30 shown in FIG. 4, the axis of rotation of the frame 30 has the same direction as an extending line of a root part 311 of the support leg 31.

In some embodiments, as shown in FIG. 2, the rotation axis of the bending portion 32 is the same as the direction of the centerline of the supporting leg 31, which means that the rotation of the bending portion 32 may be spatially formed as a geometric configuration in which the main body assumes a cone. The axis of the cone coincides with the centerline of the support leg 31 or the extension line of the centerline of the support leg 31. The centerline of the support leg 31 may be the geometric centerline thereof, for example, the connecting line from the end portion between the support leg 31 and the root 311 to the end portion between the support leg 31 and the bent portion 32.

In some embodiments, as shown in FIG. 4, the rotation axis of the frame 30 is the same with the direction of the extension line of the support leg 31 mean that the fixedly connected support leg 31 and the bending portion 32 rotate about the connection point where the end portion of the leg 31 and the optical imaging component 10 are movably connected, so that the rotation of the bending portion 32 can spatially form a substantial conical geometry shape. The axis of the conical geometry shape coincides with the extension line of the center line of the supporting leg 31. In some embodiments, the supporting leg 31 can rotate about its own centerline. In some embodiments, the rotation of the supporting leg 31 may be spatially formed into a cylindrical geometry, the axis of the cylindrical geometry is parallel to the centerline of the support leg 31. The centerline of the support leg 31 may be its geometric centerline, such as the connecting line from the end portion between the support leg 31 and the optical imaging component 10 to the end portion between the support leg 31 and the bent portion 32.

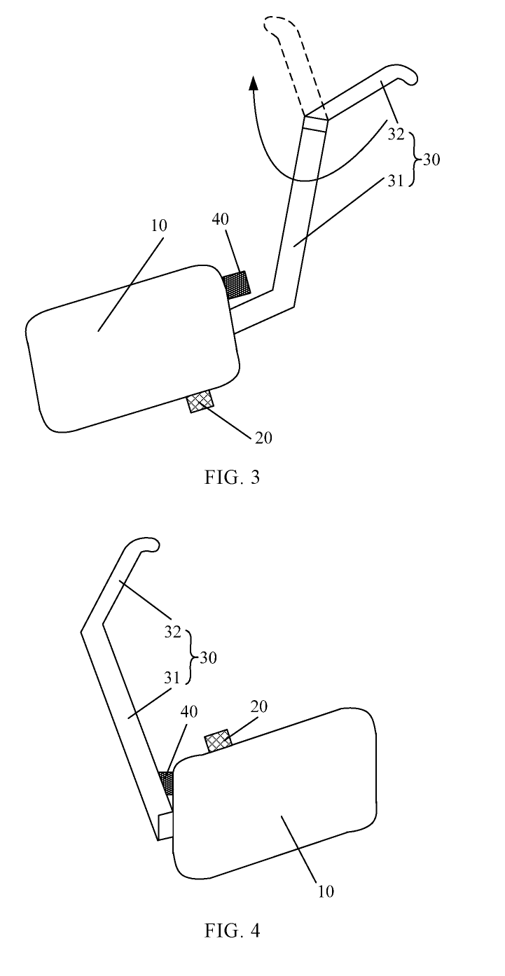

As shown in FIG. 2, the frame 30 includes: a supporting leg 31 and a bending part 32 connected to each other, wherein one end of the supporting leg 31 is fixedly connected with the optical imaging component 10, that is, a relative relationship between the supporting leg 31 and the optical imaging component 10 is fixed, the other end of the supporting leg 31 is movably connected with the bending part 32, and the bending part 32 is capable of rotating by taking a position of the movable connection with the supporting leg 31 as a center, so as to adapt to the wearing state of the wearable monocular glasses according to the embodiments of the present disclosure. For example, when the wearable monocular glasses according to the embodiments of the present disclosure are used for the left eye, the wearing state as shown in FIG. 2 is turned upside down. After the reversion, as shown in FIG. 3, the frame 30 is turned over to the right side of the optical imaging component. At this moment, by 180° rotation of the bending part 32 of the frame 30 in a direction shown by an arrow of FIG. 3 by taking a movable connection position with the supporting leg 31 as a center, the bending part 32 is turned downward from upward, and when the wearable monocular glasses are flipped to be worn on the left eye, the bending part 32 may be fitted and fixed with the left ear.

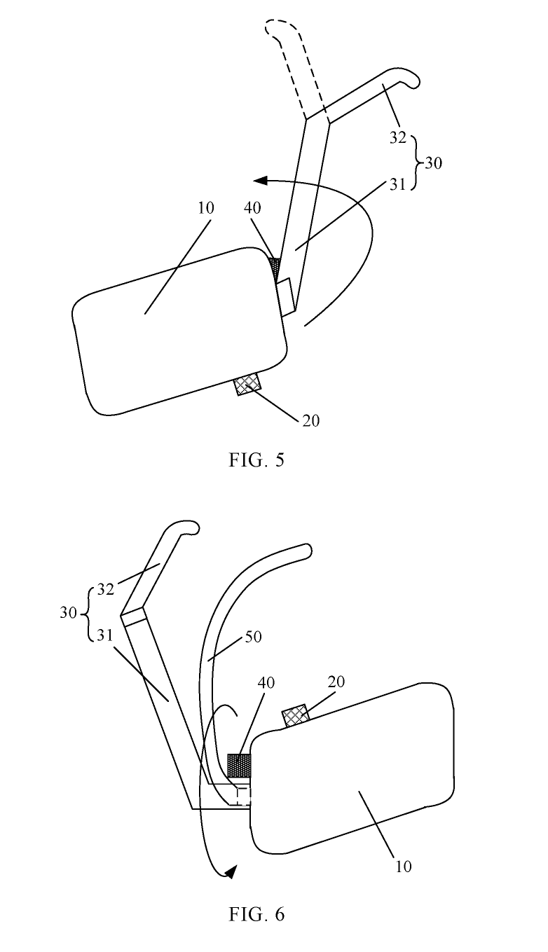

Alternatively, as shown in FIG. 4, the support leg 31 and the bending part 32 are fixedly connected to each other to form a frame 30. Through the movable connection between the support leg 31 and the optical imaging device 10, the frame 30, as a whole, is capable of rotating by taking a movable connection position between the support leg 31 and the optical imaging component 10 as a center, so as to adapt to the wearing state of the wearable monocular glasses according to the embodiments of the present disclosure. For example, when the wearable monocular glasses according to the embodiments of the present disclosure are used for wearing on the left eye, the wearing state shown in FIG. 4 is turned upside down. After being turned up, as shown in FIG. 5, the frame 30 is turned to the right side of the optical imaging component. At this moment, by 180° rotation of the frame 30 in a direction shown by an arrow of FIG. 5 by taking a movable connection position between the support leg 31 and the optical imaging component 10 as a center, the frame 30 is turned downward from upward, and when the wearable monocular glasses are flipped to be worn on the left eye, the bending part 32 of the frame 30 may be fitted and fixed with the left ear.

In some embodiments, the specific connection manner of the movable connection in the embodiments of the present disclosure is not limited, and a shaft connection, a hinge connection, a socket connection and other manners are all possible, as long as the bending part 32 can be freely rotated in a desired direction, so as to comply with the wearable monocular glasses according to the embodiments of the present disclosure.

Optionally, as shown in FIG. 6, the wearable monocular glasses according to the embodiments of the present disclosure further include a top bracket 50. A connection end of the top bracket 50 is movably connected to the optical imaging component 10 so that a free end of the top bracket 50 rotates to a head fixed position corresponding to the wearing state of the wearable monocular glasses.

It should be noted that in the embodiments of the present disclosure, the top bracket refers to a structural component that is mounted on the optical imaging component 10 and is configured to be relied on and fixed to a head of a wearer of the wearable monocular glasses. When the wearer wears the wearable monocular glasses according to the embodiments of the present disclosure, the top bracket 50 is rotated to a position near the top of the head, and a free end of the top bracket 50 may abut on the wearer's head.

As shown in FIG. 6, in order to improve the wearing stability of the wearable monocular glasses according to the embodiments of the present disclosure and prevent the wearable monocular glasses from falling off during use, optionally, a top bracket 50 which is movably connected with the optical imaging component 10 is further included. The top bracket 50 is used for fixing on the wearer's head when wearing the wearable monocular glasses according to the embodiments of the present disclosure, so as to further improve the stability by fixing on the head,in addition to hanging and fixing on the ear.

Considering that the wearable monocular glasses according to the embodiments of the present disclosure may be used for wearing on the left eye and the right eye, the top bracket 50 is movably connected with the optical imaging component 10, When the wearable monocular glasses according to the embodiments of the present disclosure change the wearing direction, as shown in FIG. 6, the top support 50 is rotated around the movable connection position along the direction shown by the arrow in FIG. 6, then the top bracket 50 is rotated correspondingly, so as to achieve the conversion of the head fixed position when wearing on the left eye and the head fixed position when wearing on the right eye.

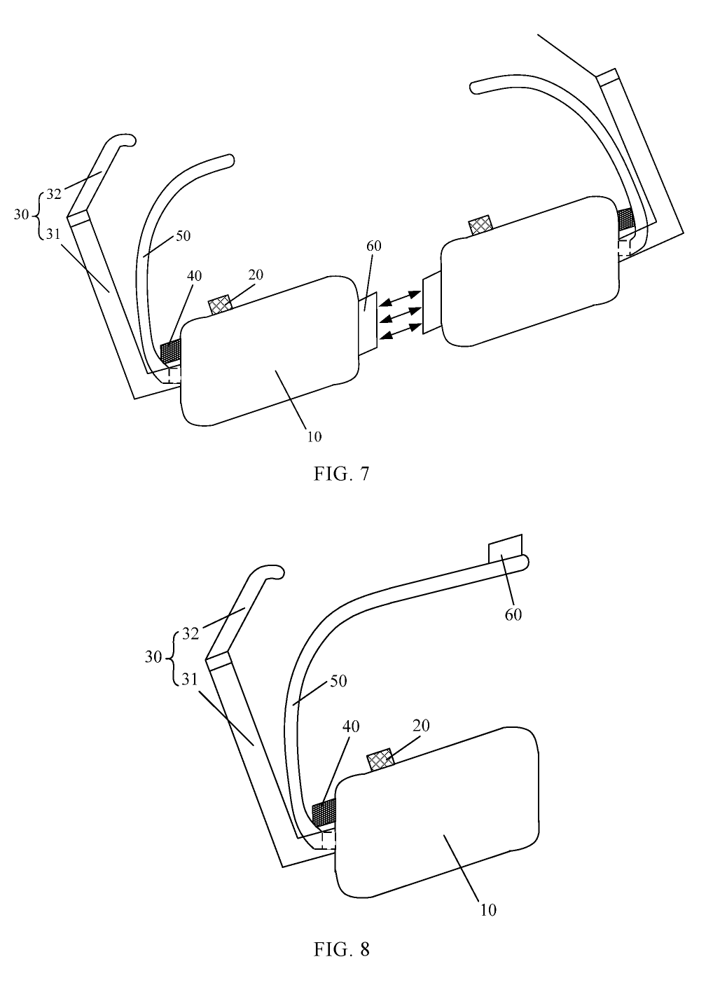

Optionally, as shown in FIG. 7, the wearable monocular glasses according to the embodiments of the present disclosure further include: a connection part 60 electrically connected with the control circuit 40, and the connection part 60 is configured to connect with a connection part 60 of another wearable monocular glasses and transmit a data indication signal or image data between the control circuits 40 of the two wearable monocular glasses connected to each other for indicating the binocular display image data.

As shown in FIG. 7, when two wearable monocular glasses are connected as binocular augmented reality glasses, by the connection between the connection parts 60 of the wearable monocular glasses, the control circuit 40 of the wearable monocular glasses instructs to perform a binocular display conversion operation according to the data indication signal which is connected by the connection part 60, and then the control circuit 40 may convert the image data into the corresponding binocular display image data, so that any two wearable monocular glasses according to the embodiments of the present disclosure, after being connected via the connection parts 60, may be converted into the binocular augmented reality glasses.

Optionally, as shown in FIG. 8, in a case where the wearable monocular glasses further include: a top bracket 50, the connection part 60 is disposed at a free end position of the top bracket 50.

As shown in FIG. 8, in a case where the wearable monocular glasses further include: a top bracket 50, the connection part 60 is provided at a free end position of the top bracket 50, and when two wearable monocular glasses are connected to each other to he used as the binocular augmented reality glasses, the signal connection is performed by the connection parts 60 of the top brackets 50, and the signal is further connected by the fixing function of the top bracket 50 to improve the stability of the signal connection.

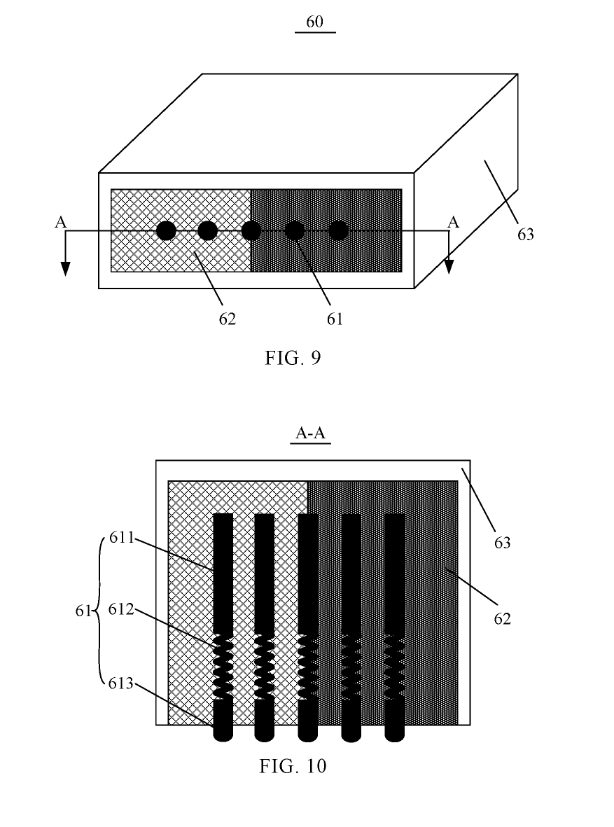

Optionally, as shown in FIG. 9, the connection part 60 includes: a plurality of signal terminals 61 arranged in a linear arrangement and a magnetic attraction member 62 disposed around the plurality of signal terminals 61. Every two symmetrically arranged signal terminals 61 of the plurality of signal terminals 61 are respectively connected to two pins of the same type of the control circuit 40; or every two symmetrically arranged signal terminals 61 of the plurality of signal terminals 61 are connected to the same pin of the control circuit 40.

It should be noted that the same type of pins of the control circuit 40 refer to pins for transmitting the same type of data, for example, a power pin which transmits a power signal; a ground pin which transmits a voltage signal of a ground terminal; and a data signal pin which transmits a data signal.

As shown in FIG. 9, the plurality of signal terminals 61 are linearly arranged, and the magnetic attraction member 62 is disposed around the signal terminal 61. When two wearable monocular glasses are connected by the connection parts 60 to form the binocular augmented reality glasses, the connection parts 60 of the two wearable monocular glasses are opposite in direction. Therefore, by connecting every two symmetrically disposed signal terminals 61 respectively to two pins of the same type of the control circuit 40, when the two connection parts 60 of opposite directions are connected to each other, the signal types of the signal terminals 61 which are connected to each other are the same, and the problem of confusing signal connections will not be occurred. Alternatively, every two signal terminals 61 which are disposed symmetrically in the plurality of signal terminals 61 are connected to the same pin of the control circuit 40, so as to prevent the problem of disordered signal connection of the signal terminals 61 which are connected with each other when two connection parts 60 in opposite directions are connected to each other.

As shown in FIG. 9, considering that the plurality of signal terminals 61 of the connection part 60 usually further include: a power signal terminal, the plurality of signal terminals 61 arranged in a linear arrangement may optionally be provided as a single number, wherein one signal terminal 61 at a central position is used for inputting a power signal, and every two signal terminals 61 arranged symmetrically from a central position to two ends are used for inputting the same type of signal.

Optionally, as shown in FIG. 9, the connection part 60 further includes: an insulating layer 63 disposed on other surfaces of the magnetic attraction member 62 besides the connecting surface of the connection part 60.

The magnetic attraction member 62 is disposed around the plurality of signal terminals 61, and the two connection parts 60 are mutually fixed by the magnetic attraction force. In order to prevent the magnetic field generating the magnetic attraction force from affecting the signal transmission of the wearable monocular glasses, the insulating layer 63 is provided around an outer surface of the magnetic attraction member 62. The plurality of signal terminals 61 are protruded from the connection surface of the connection part 60 for mutual adsorption and signal transmission with the connection surface of the other connection part 60, and therefore, the insulating layer 63 is not provided on the connection surface of the connection part 60.

Optionally, as shown in FIG. 10, the signal terminal 61 includes: a bottom conductor 611, an elastic conductor 612 and a contact 613 connected in sequence. The bottom conductor 611 and the elastic conductor 612 are enclosed within the magnetic attraction member 62 of the connection part 60, and the contact 613 is exposed from a surface of the connecting surface of the connection part 60.

As shown in FIG. 10, the contact 613 is exposed from the surface of the connecting surface of the connection part 60 for contacting with a corresponding contact 613 on the other connection part 60. In order to ensure the stability of the contact signal, the elastic conductor 612 is provided between the bottom conductor 611 and the contact 611 The elastic conductor 612 has an elasticity, and may generate a compression deformation under a pressure and may restore the compression deformation after the pressure is eliminated. When the contact 613 is contacted with a corresponding contact 613 on the other connection part 60, due to the mutual adsorption between the magnetic adsorbing members 62, the surfaces of the connecting surfaces of the two connection parts 60 are drawn toward each other and closely contacted with each other. The contact 613 is subjected to the pressure inside of the magnetic adsorbing member 62, the elasticity conductor 612 undergoes a compressive deformation by a force and always applies a pushing force on the contact 613 toward the outside of the connecting surface, and the two contacts 613 with mutual pushing force may ensure a close contact and avoid the problem of poor contact.

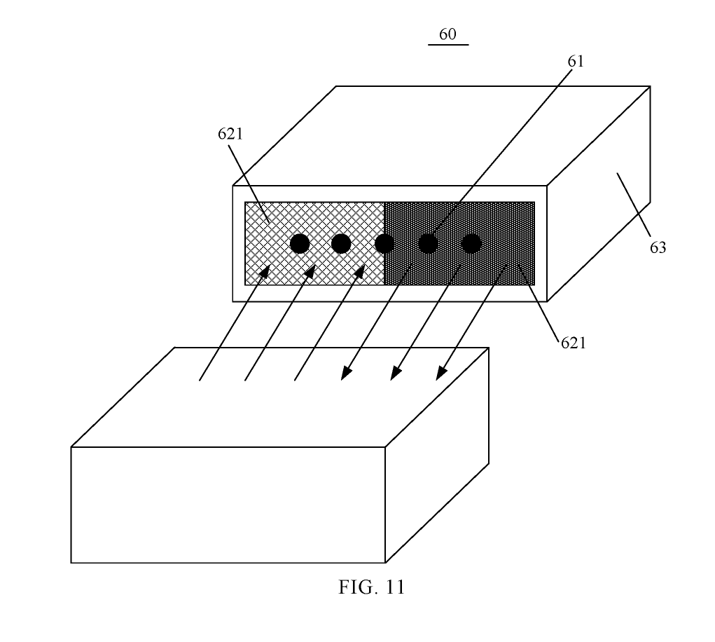

Optionally, as shown in FIG. 11, the magnetic attraction member 62 is an electromagnetic generator 621.

It should be noted that, in the embodiments of the present disclosure, the electromagnetic generator 621 is not particularly limited as long as it can generate a magnetic field in a fixed direction under an energized state.

For example, the electromagnetic generator 621 is an electromagnet. As shown in FIG. 11 (in FIG. 11, for clarity of the two connecting surfaces, the other sides and the internal structure of the opposite connection part 60 are hidden or semi-hidden by adjusting the transparency), when the two connection parts 60 are connected to each other, the magnetic attraction member 62 of the same connection part 60 includes two parts which are separated along a center. Both of the two parts are electromagnets. Current with opposite polarities are provided toward the electromagnets at two sides of the same connection part 60, that is, the electromagnets at the two sides generate magnetic fields having opposite directions of magnetic field. The two connection parts 60 have opposite directions when being connected, as the directions shown by the arrows in FIG. 11, the directions of the magnetic fields generated by the two connected electromagnets are opposite. According to the principle of attraction for unlike charges, the two connection parts 60 may be closely adsorbed to each other. At the same time, the signal terminals 61 on the two connection parts 60 are brought into contact with each other and signals may be transmitted.

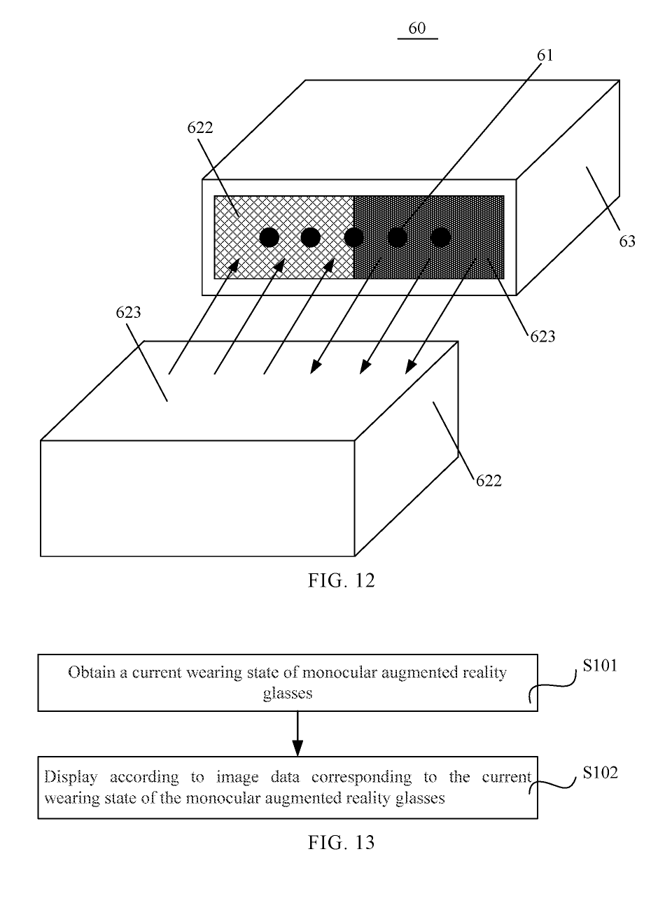

Optionally, as shown in FIG. 12, the magnetic attraction member 62 includes: a magnet 622 and a magnetic metal 623 respectively located on two sides of a symmetry line of the plurality of signal terminals 61.

It should be noted that the magnetic metal described in the embodiments of the present disclosure is not limited to a specific metal type, and may be any metal that is made of a metal material having a property of being adsorbed by the magnet 622.

As shown in FIG. 12 (in FIG. 12, for clarity of the two connecting surfaces, the other sides and the internal structure of the opposite connection part 60 are hidden or semi-hidden by transparency adjustment), during connecting the two connection parts 60 with each other, the magnetic attraction member 62 of the same connection part 60 includes two parts which are separated along a symmetry line, one of which is a magnet 622 and the other of which is a magnetic metal 623. In addition, the other connection part 60 which is connected is in an inverted state, that is, the two connection parts 60 are relatively close to each other, and the magnet 622 and the magnetic metal 623 are opposed to each other. Therefore, due to the magnetic attraction of the magnet 622 to the magnetic metal 623, the two connection parts 60 may be closely adsorbed to each other, and at the same time, the signal terminals 61 on the two connection parts 60 may be in contact with each other and may transmit signals.

Due to the nature of the magnetic metal 623 and the magnet 622, the magnet 622 may magnetically adsorb the magnetic metal as long as the magnet 622 and the magnetic metal are close to each other. Therefore, compared to the case where the magnetic attraction member 62 is the electromagnetic generator 621, when the magnetic metal 623 and the magnet 622 are used as the magnetic attraction member 62, it is unnecessary to increase the current applied to the magnetic attraction member 62 for making the electromagnetic generator 621 generate a magnetic field.

According to another aspect of the embodiments of the present disclosure, a method for controlling wearable monocular glasses is provided. As shown in FIG. 13, the method includes the following steps.

In S101, a current wearing state of the wearable monocular glasses is obtained.

In S102, display is performed based on image data corresponding to the current wearing state of the wearable monocular glasses.

As shown in FIG. 13, since the wearable monocular glasses of the embodiments of the present disclosure can realize the function of displaying for both the left eye and the right eye by flipping, for controlling the display of the wearable monocular glasses, the current wearing state of the wearable monocular glasses is obtained at first. The wearing state of the wearable monocular glasses includes a state for wearing the left eye and a state for wearing the right eye. After the current wearing state is obtained, the image data is adjusted according to the current wearing state, and then the image data corresponding to the current wearing state of the wearable monocular glasses is displayed. In this way, the image data can be processed by obtaining the wearing state at each use, so that the complete positive direction picture of the desired display image can be presented to the wearer regardless of the left-eye wearing or the right-eye wearing.

Optionally, as shown in FIG. 14, the displaying according to the image data corresponding to the wearing state of the wearable monocular glasses includes the following steps.

In S1021, if the current wearing state of the wearable monocular glasses is a preset state of the wearable monocular glasses, the display is performed according to the image data corresponding to the preset state of the wearable monocular glasses. The preset state is one of the wearing states of the wearable monocular glasses. If the current wearing state of the wearable monocular glasses is not the preset state of the wearable monocular glasses, then the image data corresponding to the preset state of the wearable monocular glasses is adjusted to the image data corresponding to the current wearing state of the wearable monocular glasses and then is displayed.

As shown in FIG. 14, firstly, when the wearer uses the wearable monocular glasses, there are two wearing states, that is, a left-eye wearing state fitted with the left eye or a right-eye wearing state fitted with the right eye. One of the left-eye wearing state and the right-eye wearing state is selected as the preset state, and the image data signal is the image data displayed corresponding to the picture of the preset state. When the current wearing state of the wearable monocular glasses matches with the preset state, the image data signal is directly outputted and displayed. When the current wearing state of the wearable monocular glasses does not match with the preset state, the image data signal is adjusted and then outputted. For example, if the left-eye wearing state is set to be the preset state and the image data signal is image data that matches the left-eye wearing state, when the current wearing state is acquired as the right-eye wearing state, if the original video data signal is still outputted and displayed, the picture seen when wearing on the right eye is the upside-down image. In this case, the image data signal is adjusted, i.e., the image data signal is reversed and then is outputted and displayed, in this way, the picture displayed in the right-eye wearing state is also a complete positive picture.

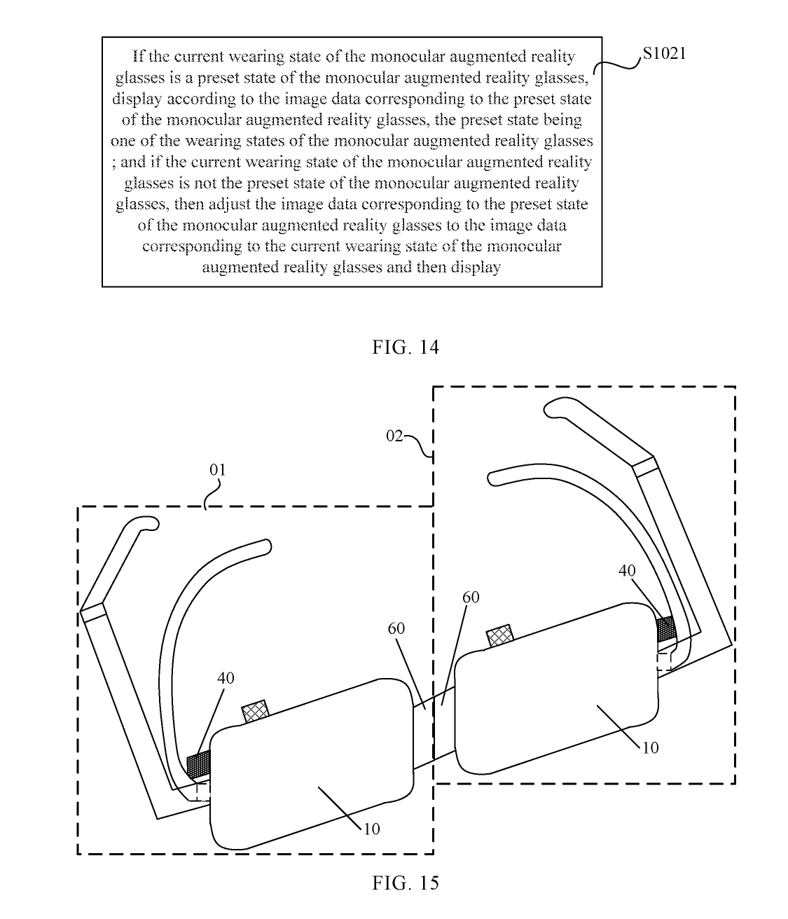

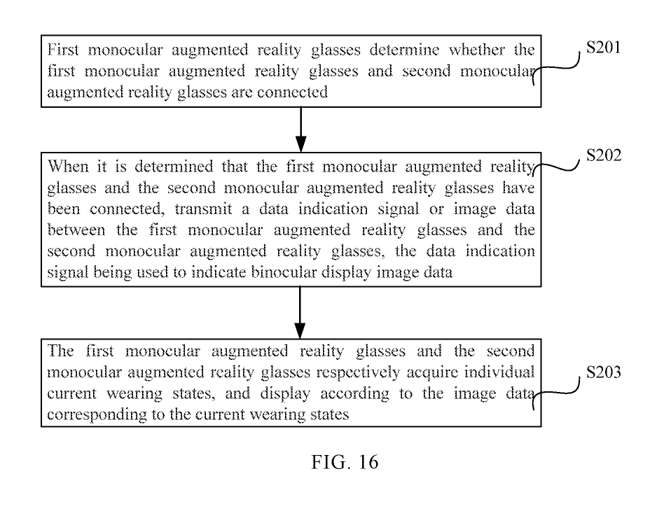

In another aspect of the embodiments of the present disclosure, a combined binocular glasses system is provided. As shown in FIG. 15, the combined binocular glasses system is formed by connecting first wearable monocular glasses 01 and second wearable monocular glasses 02 through a connection part 60. Both the first wearable monocular glasses 01 and the second wearable monocular glasses 02 are wearable monocular glasses including the connection part 60. The control circuits 40 in the first wearable monocular glasses 01 and the second wearable monocular glasses 02 are configured to transmit the data indication signal or the image data through the interconnected connection part 60. The data indication signal is used to indicate binocular display image data. The control circuits 40 in the first wearable monocular glasses 01 and the second wearable monocular glasses 02 are configured to respectively output the corresponding image data to the respective optical imaging components 10 according to the current wearing states of the first wearable monocular glasses 01 and the second wearable monocular glasses 02.

As shown in FIG. 15, the first wearable monocular glasses 01 and the second wearable monocular glasses 02 are connected to each other through the connection parts 60 to form a combined binocular glasses system. The connection parts 60 are also used for transmitting data indication signals indicating binocular display and binocular display image data. The binocular display image data includes: left-eye display image data and right-eye display image data, wherein the left-eye display and the right-eye are cooperated with each other. The first wearable monocular glasses 01 and the second wearable monocular glasses 02 constituting the combined binocular glasses system also acquire their current wearing states through respective control circuits 40 and correspondingly output the image data corresponding; to the current wearing states.

In the above specific description of the structural principle of the wearable monocular glasses and the connection manner between any two wearable monocular glasses, how the two wearable monocular glasses are combined by the connecting parts 60 to form the combined binocular glasses system has been described in detail, which is not elaborated here.

According to still another aspect of the embodiments of the present disclosure, a method for controlling a combined binocular glasses system is provided. As shown in FIG. 15, the combined binocular glasses system includes: first wearable monocular glasses 01 and second wearable monocular glasses 02 which are detachably connected. As shown in FIG. l6, the control method includes the following steps.

In S201, the first wearable monocular glasses 01 determine whether the first wearable monocular glasses 01 and the second wearable monocular glasses 02 are connected.

In S202, when it is determined that the first wearable monocular glasses 01 and the second wearable monocular glasses 02 have been connected, a data indication signal or image data is transmitted between the first wearable monocular glasses 01 and the second wearable monocular glasses 02, the data indication signal being used to indicate binocular display image data.

In S203, the first wearable monocular glasses 01 and the second wearable monocular glasses 02 respectively acquire individual current wearing states, and display according to the image data corresponding to the current wearing states.

Firstly, a connection signal is acquired by the first wearable monocular glasses 01 and it is determined whether the first wearable monocular glasses 01 and the second wearable monocular glasses 02 are connected. If there is no connection, the first wearable monocular glasses 01 still transmit and display with a monocular signal.
It should be noted that, firstly, in the combined binocular glasses system according to the embodiments of the present disclosure, the first wearable monocular glasses 01 is not limited to the left wearable monocular glasses as shown in FIG. 15, and any one of the wearable monocular glasses in the combined binocular glasses system may be used to determine whether two wearable monocular glasses are combined and connected. Here, it is not specifically limited to use which side of the wearable monocular glasses for determining whether the connection is made, and the selection may be performed by a preset manner in the combined binocular glasses system.

Secondly, there are at least two ways for determining whether the first wearable monocular glasses 01 and the second wearable monocular glasses 02 are connected. The first way may be that the control circuit 40 of each wearable monocular glasses sends a connection signal to at least one signal terminal 61 of its own connection part 60, and if the control circuit 40 of the other wearable monocular glasses at the opposite end receives the connection signal, it may be determined that the two wearable monocular glasses are connected as a combined binocular glasses system. The second way may be that a binocular control switch may be provided on the wearable monocular glasses, after the user connects the two wearable monocular glasses through the connection parts 60, the user may manually trigger the binocular control switch on the wearable monocular glasses at any side to determine the binocular connection, and the binocular display may be performed. Alternatively, the binocular connection may also be determined in other manners, which is not specifically limited in the embodiments of the present disclosure.

After it is determined that the first wearable monocular 01 and the second wearable monocular 02 are connected, a data indication signal or image data is transmitted between the first wearable monocular glasses 01 and the second wearable monocular glasses 02. The first wearable monocular glasses 01 and the second wearable monocular glasses 02 forming the combined binocular glasses system also obtain their own current wearing states through the respective control circuits 40, and correspondingly output the image data corresponding to the current wearing states.

The foregoing is merely specific implementations of the present disclosure, and the protection scope of the present disclosure is not limited thereto. Modifications and substitution which may be easily made by those skilled in the art within the technical scope disclosed by the present disclosure should all fall within the protection scope of the present disclosure. Therefore, the protection scope of the present disclosure should be defined by the protection scope of the claims.

What is claimed is:

1. Wearable monocular glasses, comprising:
an optical imaging component;
a direction sensor, fixed relative to the optical imaging component and configured to detect a wearing state of the wearable monocular glasses;
a frame, fixedly connected to the optical imaging component for enabling a user to wear the wearable monocular glasses in different wearing states; and
a control circuit, communicatively connected to the direction sensor and the optical imaging component respectively and configured to output image data corresponding to the wearing state of the wearable monocular glasses to the optical imaging component.

2. The wearable monocular glasses according to claim 1, wherein
the frame comprises: a supporting leg and a bending part connected with each other;
one end of the supporting leg is fixedly connected with the optical imaging component, and the other end of the supporting leg is movably connected with the bending part so as to rotate the bending part to an angle corresponding to the wearing state of the wearable monocular glasses; or
the supporting leg is fixedly connected with the bending part, and the supporting leg is movably connected with the optical imaging component so as to rotate the frame to an angle corresponding to the wearing state of the wearable monocular glasses.

3. The wearable monocular glasses according to claim 2, wherein a rotation axis of the bending part has the same direction as a center line of the supporting leg; or a rotation axis of the frame has the same direction as an extending line of a root part of the supporting leg.

4. The wearable monocular glasses according to claim 2, further comprising: a top bracket, wherein a connection end of the top bracket is movably connected to the optical imaging component so that a free end of the top bracket rotates to a head fixed position corresponding to the wearing state of the wearable monocular glasses.

5. The wearable monocular glasses according to claim 1, further comprising: a connection part communicatively connected with the control circuit, wherein the connection part is configured to connect with a connection part of another wearable monocular glasses and transmit a data indication signal or image data between the control circuits of two wearable monocular glasses which are connected to each other, the data indication signal being used for indicating binocular display image data.

6. The wearable monocular glasses according to claim 5, wherein in case that the wearable monocular glasses further comprise a top bracket, the connection part is provided at a free end of the top bracket.

7. The wearable monocular glasses according to claim 5, wherein the connection part comprises: a plurality of signal terminals arranged in a linear arrangement; and a magnetic attraction member disposed around the plurality of signal terminals;
wherein every two symmetrically arranged signal terminals among the plurality of signal terminals are respectively connected to two pins of the same type of the control circuit; or
every two symmetrically arranged signal terminals among the plurality of signal terminals are connected to the same pin of the control circuit.

8. The wearable monocular glasses according to claim 7, wherein the connection part further comprises: an insulating layer disposed on other surfaces of the magnetic attraction member besides a connection surface of the connection part.

9. The wearable monocular glasses according to claim 7, wherein the signal terminal comprises: a bottom conductor, an elastic conductor and a contact which are sequentially connected, the bottom conductor and the elastic conductor are enclosed in the magnetic attraction member of the connection part, and the contact is exposed from a connection surface of the connection part.

10. The wearable monocular glasses according to claim 7, wherein the magnetic attraction member is an electromagnetic generator.

11. The wearable monocular glasses according to claim 7, wherein the magnetic attraction member comprises: a magnet and a magnetic metal respectively located at two sides of a symmetry line of the plurality of signal terminals.

12. A method for controlling the wearable monocular glasses according to claim 1, comprising:
obtaining a current wearing state of the wearable monocular glasses; and
displaying according to image data corresponding to the current wearing state of the wearable monocular glasses.

13. The method for controlling the wearable monocular glasses according to claim 12, wherein the step of displaying according to the image data corresponding to the wearing state of the wearable monocular glasses comprises:
when the current wearing state of the wearable monocular glasses is a preset state of the wearable monocular glasses, displaying according to image data corresponding to the preset state of the wearable monocular glasses, the preset state being one of wearing states of the wearable monocular glasses; and
when the current wearing state of the wearable monocular glasses is not the preset state of the wearable monocular glasses, adjusting image data corresponding to the preset state of the wearable monocular glasses to image data corresponding to the current wearing state of the wearable monocular glasses and displaying the adjusted image data.

14. A combined binocular glasses system, comprising: first wearable monocular glasses and second wearable monocular glasses which are connected by connection parts, both the first wearable monocular glasses and the second wearable monocular glasses are the wearable monocular glasses according to claim 5;
the control circuit of the first wearable monocular glasses and the control circuit of the second wearable monocular glasses are configured to transmit a data indication signal or image data through the connection parts which are connected with each other, the data indication signal being used for indicating binocular display image data, and the control circuit of the first wearable monocular glasses and the control circuit of the second wearable monocular glasses are respectively configured to output corresponding image data to respective optical imaging components according to the current wearing states of the first wearable monocular glasses and the second wearable monocular glasses.

15. A method for controlling the combined binocular glasses system according to claim 14, wherein the combined binocular glasses system comprises: first wearable monocular glasses and second wearable monocular glasses which are detachably connected,
the method comprising:
determining whether the first wearable monocular glasses is connected with the second wearable monocular glasses;
when it is determined that the first wearable monocular glasses is connected with the second wearable monocular glasses, transmitting a data indication signal or image data between the first wearable monocular glasses and the second wearable monocular glasses, the data indication signal being used for indicating binocular display image data; and
obtaining individual current wearing states, and displaying according to image data corresponding to individual current wearing states, by the first wearable monocular glasses and the second wearable monocular glasses.

16. The wearable monocular glasses according to claim 2, further comprising: a connection part communicatively connected with the control circuit, wherein the connection part is configured to connect with a connection part of another wearable monocular glasses and transmit a data indication signal or image data between the control circuits of two wearable monocular glasses which are connected to each other, the data indication signal being used for indicating binocular display image data.

17. The wearable monocular glasses according to claim 3, further comprising: a connection part communicatively connected with the control circuit, wherein the connection part is configured to connect with a connection part of another wearable monocular glasses and transmit a data indication signal or image data between the control circuits of two wearable monocular glasses which are connected to each other, the data indication signal being used for indicating binocular display image data.

18. The wearable monocular glasses according to claim 4, further comprising: a connection part communicatively connected with the control circuit, wherein the connection part is configured to connect with a connection part of another wearable monocular glasses and transmit a data indication signal or image data between the control circuits of two wearable monocular glasses which are connected to each other, the data indication signal being used for indicating binocular display image data.

19. The wearable monocular glasses according to claim 8, wherein the signal terminal comprises: a bottom conductor, an elastic conductor and a contact which are sequentially connected, the bottom conductor and the elastic conductor are enclosed in the magnetic attraction member of the connection part, and the contact is exposed from a connection surface of the connection part.
